(19) United States
(12) Patent Application Publication
(10) Pub. No.: US 2005/0082699 A1
(43) Pub. Date: Apr. 21, 2005

(54) Seamless embossing shim

(76) Inventor: John Dixon, Manchester, NJ (US)

Correspondence Address: BLANK ROME LLP, 600 NEW HAMPSHIRE AVENUE, N.W., WASHINGTON, DC, 20037, US

(21) Appl. No.: 11/006,695

(22) Filed: Dec. 8, 2004

Related U.S. Application Data
(63) Continuation of application No. 10/222,780, filed on Aug. 19, 2002, now abandoned.

(51) Int. Cl. B29D 11/00; C25D 1/10

(52) U.S. Cl. 264/1.34; 205/70; 264/2.5

(57) ABSTRACT

The present invention provides methods for producing a seamless embossing shim. The shim carries a pattern to be embossed on a decorative medium, such that the image on the decorative medium contains no production seams. The methods comprise several steps. First, the a flat shim is casted onto a plastic cylinder to form a plastic master with the pattern on the outer surface to form a plastic master. Second, the plastic master is used to produce a metal master by depositing a layer of metal on the outer surface of the plastic master. Lastly, the metal master is then used to formed the seamless embossing shim by depositing a layer of metal on the inner surface of the metal master.

### FIELD OF THE INVENTION

The present invention relates generally to a seamless embossing shim used in the formation of a seamless holographic pattern on a decorative medium. Although not limited thereto, the present invention has particular utility and significance in micro-embossing applications such as, but not limited to, holographic transfers where a surface seems essentially flat, yet contains minute grooves to facilitate the reflection of light. These grooves are typically only about one-quarter of a micron in depth and their integrity must be maintained as best as possible on a die in order to effect an adequate transfer onto a decorative medium such as foil. Since groove depth is necessarily limited and often critical, flaws cannot be tolerated in reproduction of holographic patterns. The present invention addresses those needs.

### DESCRIPTION OF RELATED ART

Holographic images, patterns or designs are transferred or micro-embossed onto a web or length of material (for instance, a decorative foil on a carrier web) by a roller which carries on its outer cylindrical surface a shim having the holographic image, pattern or design. Heat and pressure are used to micro-emboss the hologram on the shim from the roller to the web or length of decorative material. This micro-embossing process is conventional. The shim which is wrapped around the roller is established in planar form by a micro-embossing operation by which a small nickel shim (typically 2 inches by 2 inches) which carries the hologram is attached to a stamp, and the hologram is micro-embossed into a planar plastic sheet by a step and repeat process. To facilitate that step and repeat operation, the planar stamping surface is indexed linearly in the X and Y directions across the planar plastic sheet until the micro-embossing is completed on the entire planar surface. The sheet is then sprayed with a silver conductive spray, and subsequently placed in an electroplating bath to form a durable nickel shim (an electroforming process). The nickel shim is removed from the plastic sheet and is wrapped around a cylinder to form a cylindrical embossing die. In addition to the long and involved process to make the nickel shim, once the nickel shim is wrapped around the cylinder, the ends of the nickel shim form a side-to-side break in the holographic pattern so that the resulting holographic foil includes a production seam made after each revolution of the cylinder. It is also noted that there will also be slight “recombining” seams created by “recombining” the design by the step and repeat process. Those recombining seams are usually insignificant since they are either difficult to see with the naked eye and/or are incorporated into the overall design on the decorative medium.

U.S. Pat. Nos. 4,790,893 and 4,968,370 both relate to the replication of information carriers such as compact discs in which the master for replicating the information carriers is a planar nickel shim with patterned or image surface depressions or pits corresponding to audio or video recorded digital information retrievable by, for instance, laser scanning. That planar nickel shim master is wrapped partially around a cylinder and is embossed onto an endless web of a thermoplastic or other material used as the base for the compact disc or other information carrier. That is similar to the above-described process in that a planar shim is partially wrapped around a cylinder for embossing onto a web of material. Again, seams will appear in the web of material, but in the replication of information carriers such as compact discs, those seams do not form part of the resulting product, and thus do not create a problem as with decorative foil.

U.S. Pat. No. 4,923,572 is directed to a cylindrical embossing tool which can be used for embossing a web of material without leaving seams. Described in this patent is a complex method of making a shim (in the form of a tube or sleeve) which carries an imaged electroform and can be placed over a carrier cylinder by introducing air into the interface of the tubular, and floating the tubular shim into position to form a supported embossing tool.

In the alternative, the tubular shim carrying the imaged electroform can be supported by a number of rollers to form an endless belt embossing tool. Significantly, however, the electroform embossing tool, whether an endless belt embossing tool or cylindrical embossing tool, is formed by first stamping a polymeric or thermoplastic embossable material layer on a cylinder with a stamper which carries an image or pattern on a concave-shaped stamping surface. A thin layer of metal such as silver could also be deposited prior to embossing the embossable material layer to render it electrically conductive and/or optically reflective.

A nickel electroform is then electroformed on the embossable material layer on the cylinder, which nickel electroform carries a negative of the stamped image or pattern. A reinforcement layer in the form of an adhesive, resin or fiberglass particles is then provided to mask the nickel electroform and provide stability and rigidity to the composite layers. Those composite layers are then removed from the cylinder, and then the reinforcement together with the nickel electroform are removed from the composite layers. The inside of the hollow cylinder having the nickel electroform is then electroplated to provide another electroform which, by virtue of the negative on the nickel electroform, carries the stamped image or pattern.

That second electroform is then removed and either placed over a cylinder or between rollers as described above. The result of this intricate process is a cylindrical embossing tool or a belt embossing tool which can emboss an image or a pattern onto material without leaving seams after each revolution of the cylinder or the belt. However, in addition to the intricacy required to prepare the cylindrical embossing tool or the belt embossing tool, there may be problems with the strength or the durability of the second electroform.

U.S. Pat. No. 5,327,825 is directed to a die for embossing a seamless pattern onto a web of material. A cylindrical surface is provided with a layer of an embossable material, preferably pure silver, a silver alloy or any other suitable embossable material. A stamp with a concave stamping surface carrying a desired pattern is used to impart the pattern on the cylindrical surface. The radius of the stamping surface matches the radius of the cylinder. The pattern is impressed onto the surface of the cylinder by repetitively imprinting the stamp on the surface of the cylinder while indexing rotationally and linearly. An important parameter in this method is to control the temperature of the stamp and the cylinder so that that silver on the cylinder surface is just hot enough to pick up the pattern, but does not flow too much causing distortion of the pattern.

A cylindrical embossing die having a relatively simple pattern burnished into the nickel plating on a steel cylinder has also been used to transfer holograms onto decorative foils in a seamless manner. However, the cylindrical embossing die was produced by an engine-turning operation using an ultra precision machining device which employs, for instance, a single crystal diamond cutting tool in a lathe-type machining process. The operation is intricate and expensive and, more importantly, is limited to extremely simple geometric patterns which can be established by such a lathe-type machining process. The only patterns known to have been established on a nickel plated cylinder by this engine-turning operation is the so-called “laser” pattern which is an extremely simple pattern. Such an operation cannot be used to establish an intricate geometric pattern on a cylinder for use in embossing a seamless pattern on, for instance, metallized PET film.

It is thus apparent that an improved method and die for effecting the seamless transfer of an image, pattern or design onto a material is warranted. Such an improvement should address the cost in manufacturing the apparatus, the durability of the die and the scope of the method in establishing images, patterns or designs for seamless transfer.

### SUMMARY OF THE INVENTION

It is an object of the present invention to provide a method for producing a seamless embossing shim. The shim carries a pattern, image or design (refer herein collectively as a “pattern”) to be embossed on a decorative medium, such that the image on the decorative medium contains no production seams.

The present invention is a multi-step process in making a seamless embossing shim. First, the a flat shim is casted onto a plastic cylinder to form a plastic master with the pattern on the outer surface. The casting is perferably accomplished by covering the outer surface of the plastic cylinder with a UV curable resin, imprinting the flat shim onto the resin, and curing the resin with UV light. Once the plastic master is formed, it is used to produce a metal master by depositing a layer of metal on the outer surface of the plastic master. Once the desired thickness is deposited, the plastic master is removed from the metal master which carries the pattern on its inner surface. To form the embossing shim of the present invention, another layer of metal is deposited on the inner surface of the metal master. Once sufficient thickness is deposited the metal master is separated from the seamless embossing shim. The resulting seamless embossing shim contains the same pattern as that on the original flat shim. The seamless embossing shim can be used to imprint a holographic pattern on a medium such as a polyethylene (PET) film, a metallized PET film, or other carriers.

The present invention also relates to the seamless embossing shim itself which is made by the method or to a shim for embossing a seamless and complex holographic or other pattern onto a decorative medium.

### BRIEF DESCRIPTION OF THE DRAWINGS

The foregoing background and summary, as well as the following detailed description of the drawings, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawing:

FIG. 1 is a diagram which shows the process of making the seamless embossing shim.

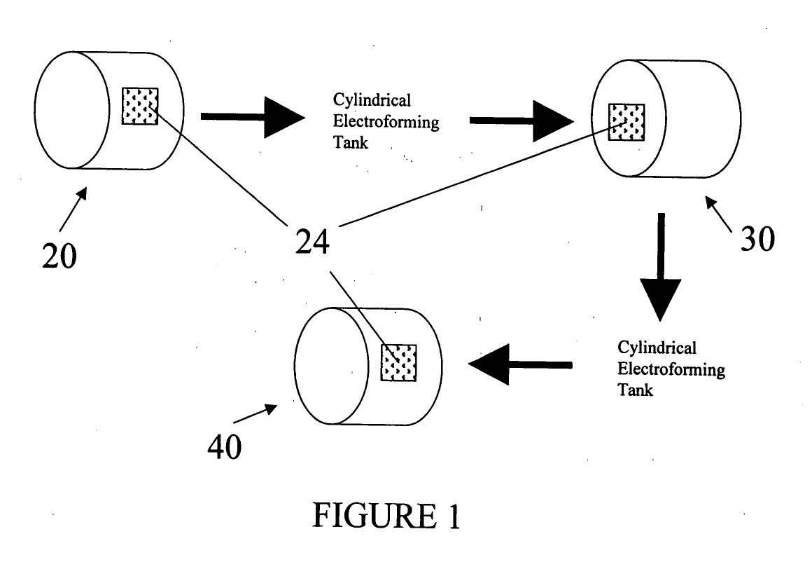

FIG. 2 is a drawing which shows a partially imprinted plastic cylinder surface.

FIG. 3 is a cross-sectional view which shows the formation of the metal master on the outer surface of the plastic master.

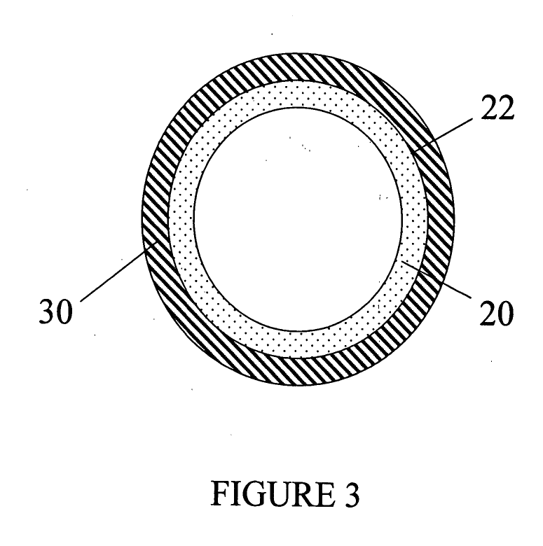

FIG. 4 is a cross-sectional view which shows the formation of the seamless embossing shim on the inner surface of the metal master.

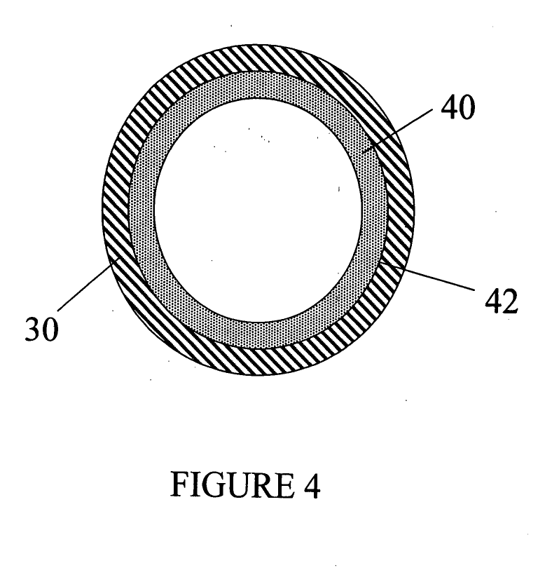

FIG. 5 is a drawing which shows the seamless embossing shim with the pattern on its outer surface.

### DETAILED DESCRIPTION OF THE PREFERRED EMBODIMENT

The method of the present invention requires the transfer of a pattern on a flat holographic shim to a cylindrical shim for seamless embossing. The flat shim can be produced by methods well known in the art such as the one disclosed in U.S. Pat. No. 5,059,499, which is incorporated herein by reference.

In the present method, the pattern on the flat holographic shim is first cast onto the outer surface of a plastic cylinder. That can be accomplished using different methods known in the prior art. A preferred method employs a UV curable resin such as vinyl resin, acetate resin, or urethane resin. In that method, the UV curable resin is pasted on the outer surface of the plastic cylinder; the pattern on the flat shim is imprinted onto the resin; and the resin is cured with UV light. Generally, because the flat shim only covers a fraction of the cylinder's outer surface, the pattern is cast onto the plastic cylinder by rotational and linear indexing through a step and repeat process.

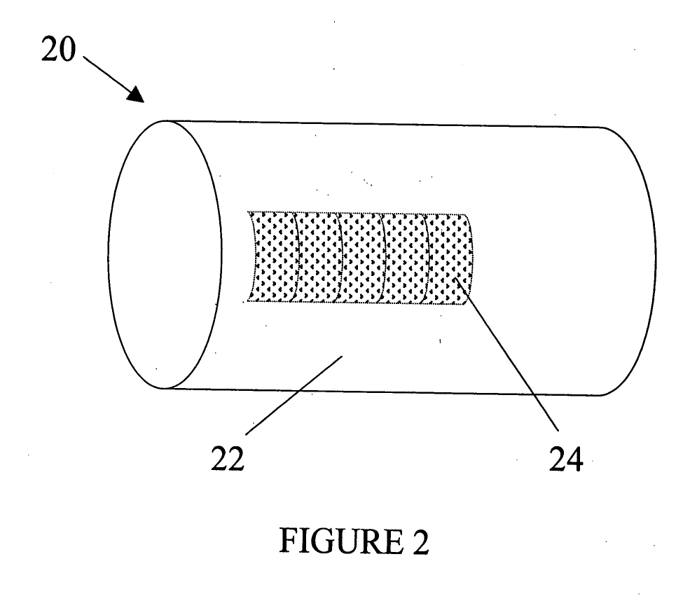

FIG. 2 shows a partially imprinted plastic cylinder 20 with an outer surface 22 having repeating holographic pattern 24. Each of the repeating holographic pattern 24 has the exact same image as that on the flat shim. The step and repeat process is performed until a desired fraction of the surface is covered. Typically, the whole surface covered with the pattern 24. The resulting plastic cylinder with the pattern imprinted on its surface is referred to herein as the plastic master.

The plastic cylinder 20 can be any suitable plastic material. Preferably, the plastic is a clear plastic. It is important, however, that if UV light is used to cure the resin, the plastic cylinder should be free of any UV inhibitor as this can adversely affect the curing process.

Once the plastic master is ready, its outer surface is ready for metal deposition. In one embodiment, the outer surface of the plastic master is prepared prior to electroforming. The preparation requires deposition of a thin layer of metal (not shown in drawings), about 1-4 Angstroms thick, preferably about 2 to 3 Angstroms, most preferably about 2 Angstroms, on the outside surface of the plastic master. The metal can be, but is not limited to, silver, nickel, copper, brass, and/or mixtures thereof. The preferred metals are silver and/or nickel.

The thin layer of metal can be deposited using methods known in the art. The preferred method is reduction metallizing. That method generally requires activating the outer surface of the plastic master with an activator, reducing the activator, and metallizing the outer surface of the plastic master in a metallization bath.

The activator generally contains conductive polymers or organic metal compounds. Naturally conductive polymers can be, but are not limited to, polydiacetylene, polyacetylene (PAc), polypyrrole (PPy), polyaniline (PAni), polythiophene (PTh), polyisothianaphthene (PITN), polyheteroarylene vinylene (PArV), in which the heteroarylene group can be e.g. thiophene or pyrrole, poly-p-phenylene (PpP), polyphenylene sulphide (PPS), polyperinaphthalene (PPN), polyphthalocyanine (PPhc) and their derivatives (which are formed e.g. of substituted monomers), their copolymers and their physical mixtures. They can exist in various states, which are described by empirical formulae differing in each case and can be converted into one another, in most cases essentially reversibly, by reactions such as oxidation, reduction, acid/base reaction or complexation. Those reactions are sometimes also called “doping” or “compensation” in the literature. From time to time, the conductive polymers are also called “organic metals” in the literature.

Usual processes, such as e.g. mechanical deposition using a doctor blade or immersion in solutions or dispersions of intrinsically conductive polymer, can be used to apply the activator. The preferred method is immersion.

Once the activator is applied to the outer surface of the plastic master, it is activated. An activation of the conductive polymer takes place in when the polymer is reduced. The reduction can take place e.g. by an electrochemical method, i.e. by means of an electric current applied from outside. However, it is preferred for the reduction to be carried out by using chemical reducing agents. Coming into consideration as chemical reducing agents are, in particular, hydrides such as boron hydrides, e.g. BH₃ and NaBH₄, and/or metals having a reducing effect in respect of the intrinsically conductive polymer, e.g. iron, aluminium or copper. Whether a metal has a reducing effect in respect of the polymer naturally depends on the actually chosen conditions in which reduction takes place. For example, the pH value and the presence of complexing agents can exert an important influence. Hydrazine and hydrazine compounds, such as hydrazine salts, e.g. hydrazinium sulphate, have proved to be particularly preferred reducing agents.

Once the surface is reduced, the plastic master is brought in contact with a solution containing the metal ion. Because the reduced conductive polymer acts as an electron carrier, it functions as a catalyst in transferring the electron(s) to the metal ion. The electron transfer from the reduced conductive polymer onto the metal cations then results in a deposition of elemental metal on the coated material. The concomitant oxidation of the conductive polymers leads at least partially to a regeneration of the conductive polymer used and opens up the possibility of subjecting it again to the reduction and deposition.

The metallizing stage is usually carried out after the reduction stage. However, it is also possible for the application of the metal to take place simultaneously with the reduction. In some cases, the simultaneous conducting of metallization and reduction can, however, be undesired, e.g. on account of the incompatibility with one another of chemicals used in reduction and metallization or for technical reasons.

After the outer surface of the plastic master 22 is prepared, electroforming is used to add a thick layer of metal on top of the thin layer (not shown in drawings). That thick layer of metal has a thickness of about 0.005 to about 0.030 inches, preferably about 0.010 to about 0.020 inches, and most preferably about 0.015 inches. The electroforming process takes place in a cylindrical electroforming tank where the cathode is attached to the outer surface 22 of the plastic master 20, where the thin layer of metal resides. The anode is preferably constructed from the same metal that is going to be deposited during metallization. For example, a nickel anode is used if nickel is the desired metal in the metallization process. When a current is applied to the system, the anodic metal oxidizes to form metal ions which then flow to the cathode (the outer surface of the prepared plastic master) and deposit thereon. The cathode then reduces the metal ion into elemental metal. The following shows the reactions at the anode and cathode for nickel:
Ni→Ni²⁺ (in solution)+2e⁻ (anode)
Ni²⁺ (in solution)+2e⁻→Ni (cathode)

Electroforming of other metals also go through similar reactions at the anode and cathode. Other metals can be, but are not limited to, silver, nickel, copper, brass, and/or mixtures thereof. The preferred metals are silver and/or nickel. The electroformed metal can be the same as or different from the thin layered metal used to prepare the surface of the plastic master.

The thickness of the electroformed metal (30) can be calculated from the following equation:
T=(M I t)/(|Z|F ρA)
where T is the thickness of the electroformed layer; M is the molar mass of the metal; I is the current; t is the time of electroformation; |Z| is the absolute value of the valence of the metal; F is Faraday constant; ρ is the density of the metal; and A is the surface area to be covered by the metal. This equation gives a theoretical maximum thickness assuming 100% efficiency of the cathode. However, because electrodes are not always 100% efficient, the actual thickness is usually less than that calculated by the equation. Generally, the efficiency of an electrode is about 95% to about 99% depending on the material used and other factors.

During electroforming, the solution in the tank and the cylinder is heated to about 100° F. to about 107° F., preferably about 102° F. to about 105° F., and most preferably about 103° F. to about 104° F. The metal layers deposited on the outer surface of the plastic mater is referred to herein as the metal master 30.

Once the desired thickness is achieved, the cylinder is removed from the electroforming tank; and the plastic master is separated from the metal master. Because the surface of the plastic master is not prepared with any bonding agent, the metal master 30 can easily be separated from the plastic master 20 by cooling to between about 5° F. to about 15° F., preferably about 8° F. to about 12° F., and most preferably about 10° F. During cooling, the plastic master 20 separates from the metal master 30 because of the difference in thermal expansion of the two materials. Because the plastic contracts faster upon cooling than the metal, the plastic master will separate from the metal master and can be removed. The cylindrical metal master 30 thus carries the pattern on its inner surface 42.

Once the metal master 30 is separated from the plastic master, its inner surface 42 is used to make the seamless embossing shim 40, the final product. The seamless embossing shim 40 is made by depositing a layer of metal on the inner surface of the metal master and then separating the two cylinders. The process of depositing the layer of metal is preferably electroforming as disclosed above.

Because the metal master 30 is composed of metal, its inner surface is preferably passivated prior to undergoing the electroforming process to prevent bonding between the metal master and the electroformed metal of the seamless embossing shim. Passivation is preferably accomplished by coating the inner surface of the metal master with a passivation agent such potassium dichromate. Another passivation method can be, but is not limited to, electrostatic cleaning.

Once the passivation of the inner surface 42 of the metal master 30 is complete, a layer of metal 40 is deposited on the inner surface by electroforming. The process of electroforming is as describe above; however, because it is desirous to deposit the metal on the inner surface of the metal master 30, the cathode is placed on the inner surface of the metal master 30. The electroforming then takes place in a cylindrical electroforming tank.

The deposited metal can be, but is not limited to, silver, nickel, copper, brass, and/or mixture thereof. The preferred metals are silver and nickel, most preferably nickel. The electroforming is complete when the thickness of the deposited metal is about 0.003 to about 0.007 inch, preferably about 0.004 to about 0.006 inch, and most preferably about 0.005 inch. The time to achieve the desired thickness can be calculated using the equation given above.

During electroforming, the solution in the tank and the cylinder is heated to about 115° F. to about 125° F., preferably about 118° F. to about 122° F., and most preferably about 120° F. The metal layer deposited on the outer surface of the plastic mater is referred to herein as the seamless embossing shim 40.

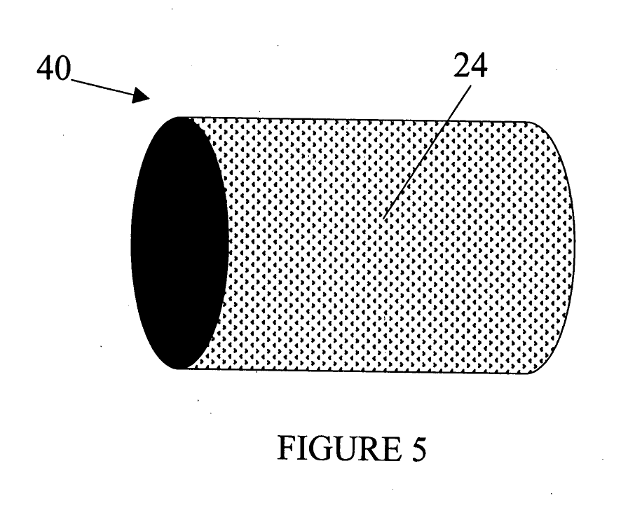

Upon completion of electroforming, the cylinder is removed from the tank and cooled. The metal master 30 is then separated from the seamless embossing shim 40 that is located on the inner surface 42 of the rmetal master 30. Because the inner surface 42 of the metal master 30 has been passivated prior to the electroforming process, the seamless embossing shim 40 can easily be pulled away from the metal master 30 by separating the two cylinders at the edge. Once separated, the seamless embossing shim 40 carries the pattern 24 on its outer surface (see FIG. 5).

In a preferred embodiment, the seamless embossing shim 40 is highly polished. It might also be desirable to coat the seamless embossing shim 40 with a protective or reinforcement layer such as chrome which would add to the durability of the micro-embossed pattern and thereby help maintain the integrity of the pattern. The resulting cylindrical seamless embossing shim 40 can then be arranged for use in conventional embossing apparatus for embossing the holographic pattern onto a decorative medium.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. A method for making a seamless embossing shim comprising the steps of
a) casting a flat shim on at least part of a plastic cylinder to form a plastic master;
b) depositing a first layer of metal on the outer surface of the plastic master to form a metal master;
c) separating the metal master from the plastic master;
d) depositing a second layer of metal on the inner surface of the metal master to form the seamless embossing shim.

2. The method of claim 1, wherein the first or second layer of metal is selected from the group consisting of silver, nickel, copper, and brass.

3. The method of claim 1, wherein step b) and step d) take place in acylindrical electroforming tank.

4. The method of claim 1, wherein the thickness of the first layer of metal in step b) is about 0.010 to about 0.020 inch.

5. The method of claim 1, wherein step a) comprises indexing the flat shim rotationally and linearly.

6. The method of claim 1, wherein step c) comprises cooling the metal master and the plastic master to about 10° F.

7. The method of claim 1, wherein the thickness of the second layer of metal in step d) is about 0.003 to about 0.007 inch.

8. The method of claim 1, wherein step b) is accomplished through electroforming.

9. The method of claim 8, wherein electroforming takes place at about 100° F. to about 107° F.

10. The method of claim 1, wherein step d) is accomplished through electroforming.

11. The method of claim 10, wherein electroforming takes place at about 115° F. to about 125° F.

12. The method of claim 1, wherein the outer surface of the plastic master is prepared prior to depositing the first layer of metal.

13. The method of claim 12, wherein the surface of the plastic master is prepared by reduction metallizing.

14. The method of claim 13, wherein reduction metallization comprising the steps of
i) activating the outer surface of the plastic master with an activator;
ii) reducing the activator; and
iii) metallizing the outer surface of the plastic master in a metallization bath.

15. The method of claim 14, wherein the activator is an organic metal compound.

16. The method of claim 1, wherein the inner surface of the metal master is passivated before depositing the second layer of metal.

17. The method of claim 16, wherein the inner surface of the metal master is passivated by coating the inner surface with a passivating agent.

18. The method of claim 17, wherein the passivating agent is potassium dichromate.

19. The method of claim 16, wherein the inner surface of the metal master is passivated by electrostatic cleaning.

20. The method of claim 1, wherein the seamless embossing shim is polished.

21. The method of claim 1, further comprising the step of separating the seamless embossing shim from the metal master.

22. A method for forming a holographic pattern on a decorative medium comprising providing the seamless embossing shim of made by the method of claim 1, and imprinting a pattern on the outer surface of the seamless embossing shim onto the decorative medium.

23. The method of claim 1, further comprising the step of polishing the seamless embossing shim.

24. The method of claim 1, further comprising the step of adding a protective or reinforcement layer to the seamless embossing shim.

25. The method of claim 24, wherein the protective or reinforcement layer is chrome.
